(19) United States
(12) Patent Application Publication
(10) Pub. No.: US 2024/0406234 A1
(43) Pub. Date: Dec. 5, 2024

(54) REMOTE CONFERENCE SYSTEM AND COMPUTER-READABLE RECORDING MEDIUM ENCODED WITH REMOTE CONFERENCE PROGRAM

(71) Applicant: Konica Minolta, Inc., Tokyo (JP)

(72) Inventor: Masaki NAKATA, Tokyo (JP)

(21) Appl. No.: 18/654,058

(22) Filed: May 3, 2024

(30) Foreign Application Priority Data
May 29, 2023 (JP) 2023-088257

(51) Int. Cl. H04L 65/403; G10L 21/034; G10L 21/0364

(52) U.S. Cl. CPC H04L 65/403; G10L 21/034; G10L 21/0364

(57) ABSTRACT

A remote conference system in which at least three terminals are communicably connected and which distribute speeches received by these terminals to other terminals, includes a hardware-processor, wherein the hardware-processor, in regard to a speech of a first terminal among the at least three terminals, controls distribution of the speech to a terminal or reproduction of the speech by a terminal such that a sound volume level of reproduction by a second terminal among the at least three terminals is suppressed to be lower than a sound volume level of reproduction by a third terminal.

### CROSS-REFERENCE TO RELATED APPLICATIONS

The entire disclosure of Japanese patent Application No. 2023-088257 filed on May 29, 2023, is incorporated herein by reference in its entirety.

### BACKGROUND OF THE INVENTION

### Technical Field

The present invention relates to a remote conference system and a computer-readable recording medium encoded with a remote conference program. In particular, the present invention relates to a remote conference system adapted to a remote conference realized using three or more terminals, and a computer-readable recording medium encoded with a remote conference program to be executed by a computer realizing the remote conference.

### Description of Related Art

In recent years, a remote conference system in which a plurality of users located in places distant from one another have a call such as a conference call via computers has widespread. As for participants participating in a remote conference, a plurality of participants located in the same area may participate in the remote conference. In this case, the plurality of participants hear each other's speeches not via the system and hears them via the system.

Japanese Unexamined Patent Publication No. 2022-165101 describes a communication management device that manages communication in regard to reception and transmission of a speech among a plurality of terminal devices, and includes a determiner that determines a terminal device that executes a speech process from among terminal devices in a same area among the plurality of terminal devices, and a terminal controller that instructs a terminal device, different from the terminal device that executes the speech process among the terminal devices in a same area, to abort the speech process.

In the communication management device described in Japanese Unexamined Patent Publication No. 2022-165101, speeches respectively collected by microphones of a terminal device that executes a speech process and a terminal device different from the terminal device that executes the speech process are prevented from being output multiple times from terminals participating a web conference.

However, because a speech process is aborted in a period during which a terminal device that executes the speech process is determined, a terminal device different from the terminal device that executes the speech process cannot reproduce a speech collected by another terminal device not in the same area. Therefore, there is a problem that participants may not be able to hear speeches uttered by all of participants participating in a conference.

### SUMMARY OF THE INVENTION

According to one aspect of the present invention, a remote conference system in which at least three terminals are communicably connected and which distribute speeches received by these terminals to other terminals, includes a hardware-processor, wherein the hardware-processor, in regard to a speech of a first terminal among the at least three terminals, controls distribution of the speech to a terminal or reproduction of the speech by a terminal such that a sound volume level of reproduction by a second terminal among the at least three terminals is suppressed to be lower than a sound volume level of reproduction by a third terminal.

According to another aspect of the present invention, a non-transitory computer readable recording medium is encoded with a remote conference program executed by a computer to which at least three terminals are communicably connected, and the remote conference program causes the computer to execute a distribution step of distributing speeches respectively received by the at least three terminals to other terminals, wherein the distribution step, in a case in which a speech of a first terminal among the at least three terminals is distributed, includes suppressing a sound volume level of reproduction by a second terminal among the at least three terminals such that the sound volume level of reproduction by the second terminal is lower than a sound volume level of reproduction by a third terminal.

According to yet another aspect of the present invention, a non-transitory computer readable recording medium is encoded with a remote conference program executed by a computer controlling a terminal communicably connected to at least two terminals which are a first terminal and a second terminal, and the remote conference program causes the computer to execute a distribution step of distributing a received speech to the first terminal and the second terminal, and a reproduction step of reproducing a speech distributed from any one of the first terminal and the second terminal, wherein the reproduction step includes suppressing a sound volume level of reproduction of a speech distributed from the first terminal such that the sound volume level of reproduction of the speech is lower than a sound volume level of reproduction of a speech distributed from the second terminal.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating one example of the system configuration of a remote conference system in one embodiment of the present invention;

FIG. 2 is a block diagram illustrating one example of the hardware configuration of a server;

FIG. 3 is a block diagram illustrating one example of the hardware configuration of a PC;

FIG. 4 is a diagram illustrating one example of the functions of a CPU included in the server in the present embodiment;

FIG. 5 is a diagram illustrating one example of an environment information setting screen;

FIG. 6 is a diagram illustrating one example of a terminal-set table;

FIG. 7 is a diagram illustrating one example of the functions of a CPU included in the PC in the present embodiment;

FIG. 8 is a flowchart illustrating one example of a flow of a server-side remote conference process;

FIG. 9 is a flowchart illustrating one example of a speech suppressing process;

FIG. 10 is a flowchart illustrating one example of a speech blocking process;

FIG. 11 is a flowchart illustrating one example of a terminal-side remote conference process;

FIG. 12 is a diagram illustrating one example of the functions of a CPU included in a server in a second embodiment;

FIG. 13 is a diagram illustrating one example of the functions of a CPU included in a PC in the second embodiment;

FIG. 14 is a flowchart illustrating one example of a flow of a server-side remote conference process in the second embodiment;

FIG. 15 is a first flowchart illustrating one example of a flow of a terminal-side remote conference process in the second embodiment; and

FIG. 16 is a second flowchart illustrating one example of a flow of the terminal-side remote conference process in the second embodiment.

### DETAILED DESCRIPTION

Hereinafter, one or more embodiments of the present invention will be described with reference to the drawings. However, the scope of the invention is not limited to the disclosed embodiments.

Embodiments of the present invention will be described below with reference to the drawings. In the following description, the same components are denoted by the same reference numerals. Their names and functions are the same. Therefore, a detailed description thereof will not be repeated.

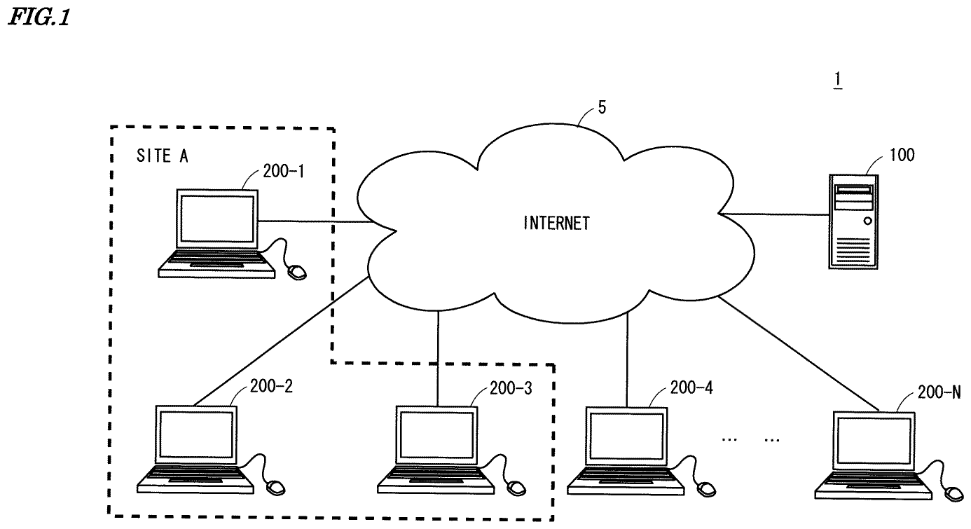

FIG. 1 is a diagram illustrating one example of the system configuration of a remote conference system in one embodiment of the present invention. With reference to FIG. 1, the remote conference system 1 includes a server 100 and personal computers (hereinafter referred to as “PCs”) 200-1, 200-2, 200-3, 200-4 to 200-N. Note that N is a positive integer, and is equal to or larger than 5 here. The server 100 and the PCs 200-1 to 200-N are respectively connected to the Internet 5 and can communicate with one another.

Each of the PCs 200-1 to 200-N includes a camera, a microphone that collects a speech and a speaker that outputs a speech. Each of the PCs 200-1 to 200-N is a general computer, and their main hardware configuration and functions thereof are the same.

Instead of the PCs 200-1 to 200-N, an information communication device such as a Personal Digital Assistance (PDA) or a smartphone may be used as long as the device includes a camera, a microphone, a speaker and a communication function. Further, the network is not limited to the Internet 5, and other networks may be used as long as the server 100 and the PCs 200-1 to 200-N can communicate with each other. A network may be a Local Area Network (LAN) or a Wide Area Network (WAN), for example.

In the remote conference system 1, a conference participant operates any one of the PCs 200-1 to 200-N to participate in a conference. Participants who respectively operate the PCs 200-1 to 200-N are referred to as users P-1 to P-N. In other words, a user P-n (n is an integer that is not less than 1 and not more than N) operates a PC 200-n. In the present embodiment, the PC 200-1, the PC 200-2 and the PC 200-3 are arranged in a site A, and the PCs 200-4 to 200-N are arranged in a place different from the site A, by way of example. The site A indicates a room in a building, for example. Hereinafter, the PCs 200-1 to 200-N are collectively referred to as a PC 200. A program for participating in a conference is installed in each of the PCs 200-1 to 200-N, and the conference takes place when each of the PCs 200-1 to 200-N communicates with the server 100. In addition to a dedicated program for communicating with the server 100, a program installed in each of the PCs 200-1 to 200-N may be a general browser program in a case in which the server 100 provides a web service.

A remote conference system is implemented by execution of a remote conference program by the server 100. The server 100 communicates with the PCs 200-1 to 200-N, and transmits data received from each of the PCs 200-1 to 200-N to each of the other PCs 200-1 to 200-N.

Data transmitted and received between each of the PCs 200-1 to 200-N and the server 100 includes a speech data piece representing a speech, an image data piece representing an image and an application data piece. Images include a still image and a moving image. Data transmitted and received between each of the PCs 200-1 to 200-N and the server 100 may be compressed data or may be uncompressed data.

The server 100 controls data to be transmitted to each of the PCs 200-1 to 200-N. For example, the server 100 can transmit a speech data piece received from each of the PCs 200-1 to 200-N to all of the PCs 200-1 to 200-N. Further, as for image data, the server 100 can collect image data received from each of the PCs 200-1 to 200-N and transmit the image data to each of the PCs 200-1 to 200-N.

In response to a request from each of the PCs 200-1 to 200-N, the server 100 determines a speech data piece, an image data piece and an application data piece to be transmitted and transmits them. Therefore, images displayed on the respective PCs 200-1 to 200-N may be the same or different, and speeches output from the respective PCs 200-1 to 200-N may be the same or different. Each of the PCs 200-1 to 200-N may process a plurality of speech data pieces received from the server 100 and output them. In this case, because it is not necessary for the server 100 to process a speech data piece, it reduces a load. Furthermore, each of the PCs 200-1 to 200-N may process a plurality of image data pieces received from the server 100 and display them. In this case, because it is not necessary for the server 100 to process the plurality of image data pieces, it reduces a load.

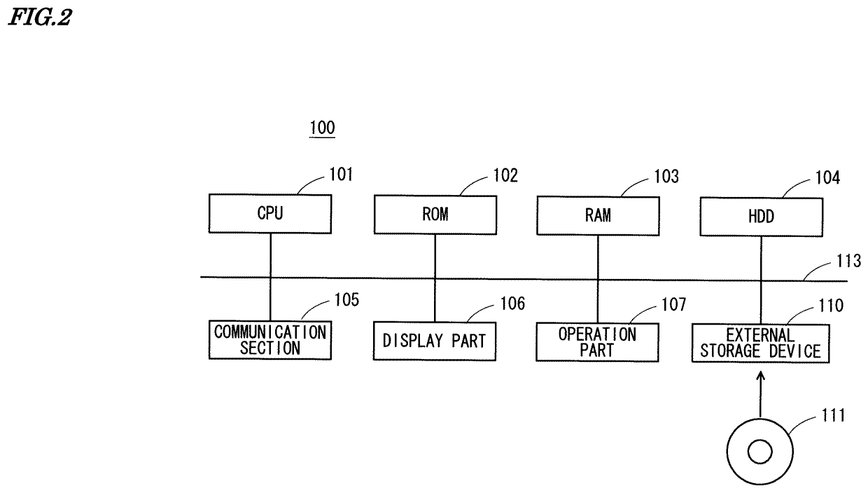

FIG. 2 is a block diagram illustrating one example of the hardware configuration of a server. With reference to FIG. 2, the server 100 is a computer that executes an arithmetic process and includes a Central Processing Unit (CPU) 101 for controlling the server 100 as a whole, a ROM (Read Only Memory) 102 for storing a program to be executed by the CPU 101, a RAM (Random Access Memory) 103 that is used as a work area for the CPU 101, a HDD 104 for storing data in a non-volatile manner, a communication section 105 that connects the CPU 101 to the Internet 5, a display part 106 that displays images, an operation part 107 that receives an input operation and an external storage device 110. Each of those is connected to a bus 113.

The communication section 105 is an interface for connecting the server 100 to the Internet 5. Therefore, the CPU 101 can communicate with the PCs 200-1 to 200-N connected to the Internet 5 via the communication section 105.

A Compact Disk Read Only Memory (CD-ROM) 111 is attached to the external storage device 110. The CPU 101 controls the external storage device 110 to read data stored in the CD-ROM 111.

In the present embodiment, the CPU 101 executes a program stored in the ROM 102 or the HDD 104. Further, the CPU 101 may control the external storage device 110 to read a program to be executed by the CPU 101 from the CD-ROM 111, and may store the read program in the RAM 103 for execution.

Further, the CPU 101 downloads a program from a computer connected to the Internet 5, and stores the program in the HDD 104. Further, in a case in which the computer connected to the Internet 5 writes a program into the HDD 104, the program is stored in the HDD 104. The CPU 101 may load the program stored in the HDD 104 into the RAM 103 and execute the program.

A recording medium for storing a program to be executed by the CPU 101 is not limited to the CD-ROM 111 but may be a flexible disc, a cassette tape, an optical disc (Magnetic Optical Disc (MO)/Mini Disc (MD)/Digital Versatile Disc (DVD)), an IC card, an optical card, or a semiconductor memory such as a mask ROM or an Erasable Programmable ROM (EPROM). The program referred to here includes not only a program directly executable by the CPU 101 but also a source program, a compressed program, an encrypted program and the like.

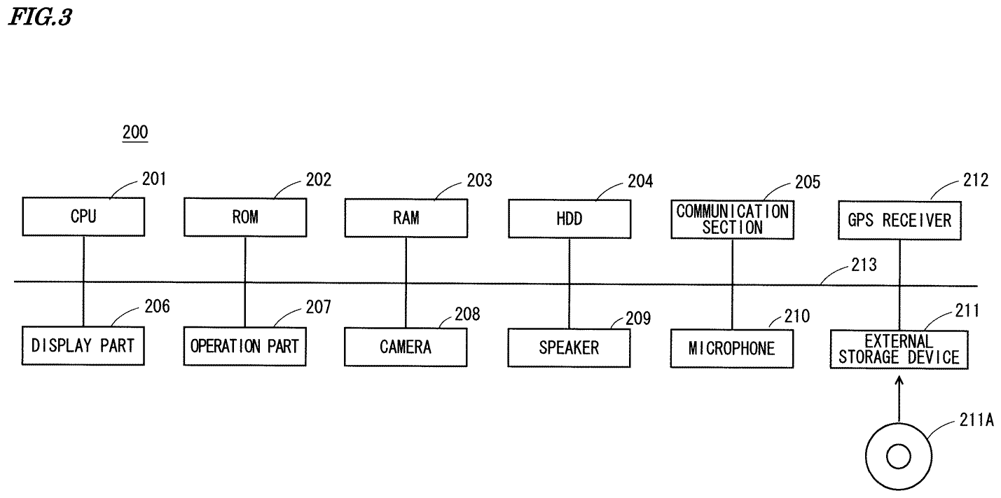

FIG. 3 is a block diagram illustrating one example of the hardware configuration of a PC. With reference to FIG. 3, the PC 200 is a computer that executes arithmetic processing, and includes a CPU 201 for controlling the PC 200 as a whole, a ROM 202 for storing a program to be executed by the CPU 201, a RAM 203 that is used as a work area for the CPU 201, a HDD 204 for storing data in a non-volatile manner, a communication section 205 that connects the CPU 201 to the Internet 5, a display part 206 that displays images, an operation part 207 that receives an input operation performed by a participant who is a user, a camera 208 that picks up an image of a participant, a speaker 209 that outputs a speech, a microphone 210 that collects a speech of an operator, an external storage device 211 and a GPS receiver 212. Each of those is connected to a bus 213.

A CD-ROM 211A is attached to the external storage device 211. The CPU 201 controls the external storage device 211 to read the data stored in the CD-ROM 211A.

A module in which at least two of the camera 208, the speaker 209 and the microphone 210 are integrated may be connected to the PC 200. The module includes a headset in which the speaker 209 and the microphone 210 are integrated, for example.

The GPS receiver 212 receives signals transmitted from a plurality of Global Positioning System (GPS) satellites and analyzes the signals to calculate a position. The GPS receiver 212 outputs position information representing the detected position to the CPU 201. Note that PC 200 does not have to include the GPS receiver 212. In this case, a user may input position information to the PC 200, and the position information may be stored in the HDD 204.

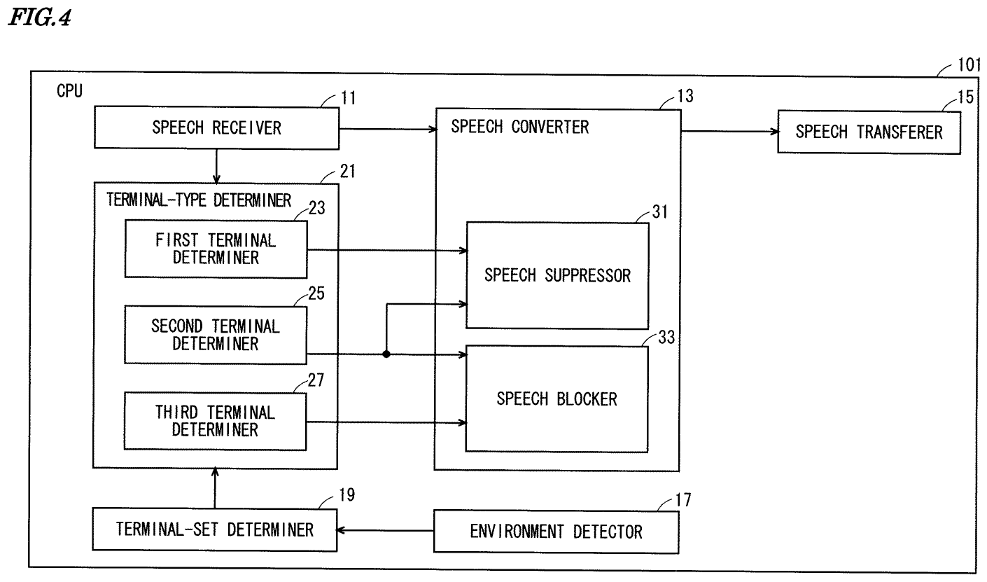

FIG. 4 is a diagram illustrating one example of the functions of a CPU included in the server in the present embodiment. The functions illustrated in FIG. 4 are implemented by the CPU 101 included in the server 100 when the CPU 101 executes a server-side remote conference program stored in the ROM 102, the HDD 104 or the CD-ROM 111. The server-side remote conference program is part of the remote conference program. With reference to FIG. 4, the CPU 101 includes a speech receiver 11, a speech converter 13, a speech transferer 15, an environment detector 17 and a terminal-set determiner 19.

The environment detector 17 detects environment information of the users P-1 to P-N participating in a remote conference. Environment information is the information that can specify the relative positional relationship among the plurality of users P-1 to P-N participating in the remote conference.

The environment detector 17 detects the environment information based on first type information determined by each of the users P-1 to P-N. The first type information is the information determined by each of the users P-1 to P-N. The environment detector 17 acquires the first type information by accepting respective operations input by the users P-1 to P-N who respectively operate the PCs 200-1 to 200-N. Here, the first type information is the relative position information representing that a speech of the other party can be heard between two participants, by way of example.

The environment detector 17 causes the PC 200-1 to display an environment information setting screen, and acquires, as first type information, relative position information input by the user P-1 operating the PC 200-1 to the PC 200-1 in accordance with the environment information setting screen.

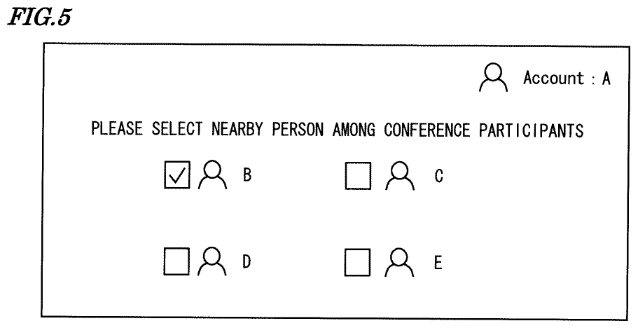

FIG. 5 is a diagram illustrating one example of an environment information setting screen. FIG. 5 illustrates an environment information setting screen displayed on the PC 200-1 in a case in which five users P-1 to P5 participate in a remote conference. Here, the account names of the users P-1 to P-5 are A, B, C, D and E, respectively. An icon is displayed at the left of each account name. An icon is an image unique to a user such as the photograph of a user's face. Although being represented by the same simplified image in the diagram, the icons are actually different images.

The account name and the icon of the user P-1 are displayed at the top of the environment information setting screen, and it is indicated that the environment information setting screen is for the user P-1 to make settings. The message “PLEASE SELECT NEARBY PERSON AMONG CONFERENCE PARTICIPANTS” is displayed above the accounts of the users P-2 to P-5. Further, check boxes are respectively displayed at the left of the icons of the users P-1 to P-5.

The user P-1 performs an operation of providing a check mark in the check box of a user located near the user P-1 among the other users P-2 to P-5, so that relative position information is input to the PC 200-1. The user located near the user P-1 is located within a certain distance from the user P1 such that the user P-1 can hear a speech uttered by the user. In FIG. 5, it is indicated that a check mark is provided in the check box of the user P-2 whose account name is B. In this case, the user identification information of the user P-2 is input to the PC 200-1 by the user P-1. The PC 200-1 transmits, to the server 100, the relative position information representing that the user P-1 and the user P-2 can hear each other. The relative position information in this case includes the user identification information for identifying each of the user P-1 and the user P-2.

In the present embodiment, the user P-1, the user P-2 and the user P-3 are located in the same site A. Here, the user P-1 can hear a speech uttered by the user P-2 but cannot hear a speech uttered by the user P-3, the user P-2 can hear a speech uttered by each of the user P-1 and the user P-3, and the user P-3 can hear a speech uttered by the user P-2 but cannot hear a speech uttered by the user P-1, by way of example.

Returning to FIG. 4, the environment detector 17 receives relative position information from each of the PCs 200-1 to 200-3. The relative position information received from the PC 200-1 includes the user identification information of each of the user P-1 and the user P-2. Two relative position information pieces are received from the PC 200-2, one includes the user identification information of each of the user P-2 and the user P-1, and the other one includes the user identification information of each of the user P-2 and the user P-3. The relative position information received from the PC 200-3 includes the user identification information of each of the user P-3 and the user P-1. One of the two relative position information pieces received from the PC 200-2 is the same as the relative position information received from the PC 200-1, and the other one is the same as the relative position information received from the PC 200-3. Although the relative position information is received from each of the users P-1 to P-3 here, by way of example, relative position information may be received from at least one of a plurality of participants. In the present example, the user P-2 inputs the relative position information.

A correspondence table in which the users P-1 to P-N are associated with and the PCs 200-1 to 200-N is stored in the HDD 104 in advance. With reference to the correspondence table, based on the relative position information received from the PC 200-2, the environment detector 17 detects the environment information including the device identification information of each of the PC 200-1 operated by the user P-1 and the PC 200-2 operated by the user P-2, and the environment information including the device identification information of each of the PC 200-2 operated by the user P-2 and the PC 200-3 operated by the user P-3. The environment detector 17 outputs the detected environment information to the terminal-set determiner 19.

The terminal-set determiner 19 determines a terminal set based on the environment information received from the environment detector 17. A terminal set includes two selected PCs from among the PCs 200-1 to 200-N. The terminal-set determiner 19 determines two devices specified by two device identification information pieces included in environment information as a terminal set. The terminal-set determiner 19 outputs two terminal sets to the terminal-type determiner 21.

In the present embodiment, the terminal-set determiner 19 receives the two environment information pieces from the environment detector 17. The terminal-set determiner 19 determines a terminal set including the PC 200-1 and the PC 200-2 based on one environment information piece, and determines a terminal set including the PC 200-2 and the PC 200-3 based on the other environment information piece. The terminal-set determiner 19 stores a terminal-set table representing terminal sets in the HDD 104.

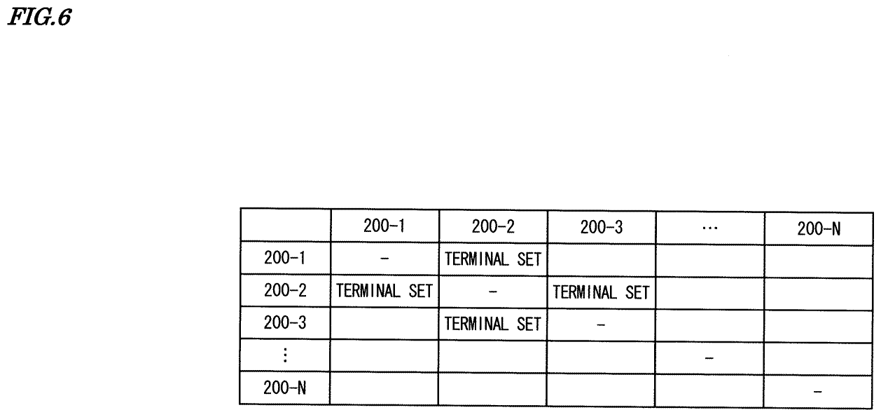

FIG. 6 is a diagram illustrating one example of a terminal-set table. With reference to FIG. 6, the user identification information pieces of the users P-1 to P-N are described in the top row and the leftmost column. Here, the PCs 200-1, 200-2, 200-3, 200-N are described, and the PCs 200-4 to 200(N−1) are not described. With reference to FIG. 6, it is illustrated that the PC 200-1 and the PC 200-2 are paired as a terminal set, the PC 200-2 and the PC 200-3 are paired as a terminal set, and the any other two sets are not terminal sets.

Returning to FIG. 4, the speech receiver 11 controls the communication section 105 to receive a speech data piece from any one of the PCs 200-1 to 200-N. In response to receiving a speech data piece, the speech receiver 11 outputs the speech data piece to the speech converter 13. Further, the speech receiver 11 outputs, to the speech converter 13 and the terminal-type determiner 21, the device identification information for identifying a device that has transmitted a speech data piece from among the PCs 200-1 to 200-N. The speech receiver 11 may receive speech data pieces from two or more of the PCs 200-1 to 200-N at the same time.

The terminal-type determiner 21 receives terminal sets from the terminal-set determiner 19, and receives, from the speech receiver 11, the device identification information of a device that has transmitted a speech data piece. The terminal-type determiner 21 includes a first-terminal determiner 23, a second-terminal determiner 25 and a third-terminal determiner 27.

In response to receiving device identification information from the speech receiver 11, the first-terminal determiner 23 determines a device specified by the device identification information as a first terminal. The first-terminal determiner 23 outputs the device identification information for identifying the first terminal to the speech converter 13.

With reference to the terminal sets received from the terminal-set determiner 19, the second-terminal determiner 25 determines a device to be paired with the first terminal as a second terminal. The second-terminal determiner 25 outputs the device identification information for identifying a second terminal to the speech converter 13.

The third-terminal determiner 27 determines devices other than the first terminal and the second terminal among the PCs 200-1 to 200-N as third terminals. The third-terminal determiner 27 outputs the device identification information for identifying the third terminals to the speech converter 13.

The terminal-type determiner 21 determines a first terminal, a second terminal and a third terminal relative to a speech data piece. For the purpose of explanation, speech data pieces respectively received from the PCs 200-1 to 200-N are referred to as speech data pieces D-1 to D-N. Here, the PC 200-1 and the PC 200-2 are determined to be paired as a terminal set, and the PC 200-2 and the PC 200-3 are determined to be paired as a terminal set. In regard to the speech data piece D-1, the PC 200-1 is determined as a first terminal, the PC 200-2 is determined as a second terminal, and the other PCs 200-3 to 200-N are determined as third terminals. Similarly, in regard to the speech data piece D-2, the PC 200-2 is determined as a first terminal, the PC 200-1 and the PC 200-3 are determined as second terminals, and the other PCs 200-4 to 200-N are determined as third terminals. In regard to the speech data piece D-3, the PC 200-3 is determined as a first terminal, the PC 200-2 is determined as a second terminal, and the other PCs 200-1, 200-4 to 200-N are determined as third terminals.

Speech data pieces may be received from two devices specified as a terminal set at the same time. In a case in which two devices that respectively transmit two speech data pieces that are received at the same time are paired as a terminal set, one of the two speech data pieces is given priority. Out of the two speech data pieces, the one that is received first may be given priority, the one having a higher sound volume level may be given priority, or any one of them may be given priority. Here, the terminal-type determiner 21 prioritizes the speech data piece that is received at an earlier point in time over a speech data piece that is received at a later point in time, by way of example.

The speech converter 13 receives a speech data piece from the speech receiver 11, and receives the device identification information of each of a first terminal, a second terminal and a third terminal corresponding to the speech data piece from the terminal-type determiner 21. The speech converter 13 converts the speech data piece received from the speech receiver 11 for each output destination.

The speech converter 13 includes a speech suppressor 31 and a speech blocker 33. The speech suppressor 31 suppresses a speech data piece, which is received from a first terminal and is transmitted to a second terminal. The speech suppressor 31 does not suppress a speech data piece, which is received from a first terminal and is to be transmitted to a third terminal. Specifically, the speech suppressor 31 makes setting such that a speech data piece received from a first terminal is not to be transmitted to a second terminal. Further, the speech suppressor 31 sets the sound volume level of a speech data piece received from a first terminal to a level lower than the sound volume level of a speech data piece to be transmitted to a third terminal. A sound volume level is part of a speech data piece, and is a value indicating a sound volume level at which a speech of the speech data piece is reproduced.

In a period during which a speech data piece is received from a first terminal, the speech blocker 33 blocks a speech data piece received from a second terminal corresponding to the speech data piece. Specifically, the speech blocker 33 makes setting such that, in a period during which a speech data piece is received from a first terminal, a speech data piece received from a second terminal corresponding to the speech data piece is not transmitted to a first terminal or a third terminal.

Two devices, respectively specified by two device identification information pieces, included in a terminal set have a positional relationship in which the two users operating the devices can hear a speech uttered by another user. Here, the PC 200-1 and the PC 200-2 are included in a terminal set, and the PC 200-2 and the PC200-3 are included in a terminal set, by way of specific example. In this case, each of the user P-1 and the user P-3 directly hears a speech uttered by the user P-2. On the other hand, because a speech uttered by the user P-2 in a remote conference is collected by the microphone 210 of the PC 200-2, the speech receiver 11 receives a speech data piece D-2 representing the speech uttered by the user P-2 from the PC 200-2. In this case, it is determined that, in regard to the speech data piece D-2, the PC 200-2 is a first terminal, the PC 200-1 and the PC 200-3 are second terminals, and the PCs 200-4 to 200-N are third terminals.

Because the PC 200-1 and the PC 200-3 are the second terminals in regard to the speech data piece D-2, the speech suppressor 31 makes setting such that the speech data piece D-2 received from the PC 200-2 is not to be transmitted to the PC 200-1 or the PC 200-3. Therefore, a reproduced speech of the speech data piece D-2 is not output from the speakers 209 included in the PC 200-1 and the PC 200-3. Therefore, it is possible to prevent each of the users P-1 and P-3 from hearing the same speech from two sound sources. Further, the speech suppressor 31 makes setting such that the sound volume level of the speech data piece D-2 the output destination of which are the PC 200-1 and the PC 200-3 is a low level. Therefore, the reproduced speech of the speech data piece D2 is output from the speakers 209 included in the PC 200-1 and the PC 200-3 at a low sound volume level. Therefore, it is possible to cause the user P-1 and the user P-3 to hear the same speech from the two sound sources at different sound volume levels.

Further, a speech uttered by the user P-2 in a remote conference is collected by the microphone 210 included in the PC 200-2, and is also collected by the respective microphones 210 included in the PC 200-1 and the PC 200-3. Therefore, the speech receiver 11 receives the speech data piece D-2 representing the speech uttered by the user P-2 from the PC 200-2, and also receives the speech data piece D-1 representing the speech uttered by the user P-2 from the PC 200-1 and the speech data piece D-3 representing the speech uttered by the user P-2 from the PC 200-3. The speech blocker 33 makes setting such that the speech data piece D-1 and the speech data piece D-3 respectively received from the PC 200-1 and the PC 200-3, which are the second terminals corresponding to the speech data piece D-2, are not to be transmitted to the PC 200-2 or the PCs 200-4 to 200-N.

Therefore, the reproduced speeches of the speech data piece D-1 and the speech data piece data-D-3 are not output from the speakers 209 included in the respective PCs 200-2, 200-4 to 200-N. Therefore, it is possible to cause the users P4 to PN to hear only the reproduced speech of the speech data piece D-2. Further, in a case in which the speech blocker 33 does not block the speech data piece D-1 or the speech data piece D-3, the speech data piece D-1 is erroneously identified as a speech uttered by the user P-1, and the speech data piece D-3 is erroneously identified as a speech uttered by the user P-3. In particular, in a case in which a process of displaying or recording a character string obtained by speech recognition of a speech data piece in association with the name of a speaker or the like is executed, an error occurs in the association. Because the speech blocker 33 blocks the speech data piece D-2 received from the PC 200-2, which is the second terminal corresponding to the speech data piece D-1, it is possible to prevent an error in associating the character string with the name of the speaker.

For each speech data piece, the speech transferer 15 receives a first terminal, a second terminal and a third terminal corresponding to the speech data piece, and the converted speech data piece of the speech data piece from the speech converter 13. The speech transferer 15 controls the communication section 105 to transmit a speech data piece to each of a first terminal, a second terminal and a third terminal. Specifically, the speech transferer 15 transmits a speech data piece received from the first terminal to the third terminal corresponding to the speech data piece received from the first terminal, and does not transmit the speech data piece received from the first terminal to the second terminal, or transmits the speech data piece received from the first terminal to the second terminal at a sound volume level lower than the sound volume level of the speech data piece to be transmitted to the third terminal. Further, the speech transferer 15 does not transmit a speech data piece received from the second terminal corresponding to the speech data piece received from the first terminal to the first terminal or the third terminal. The speech transferer 15 may transmit, to one of the PCs 200-1 to 200-N, a plurality of speech data pieces respectively received from a plurality of devices, or may transmit one speech data piece obtained when a plurality of speech data pieces are combined.

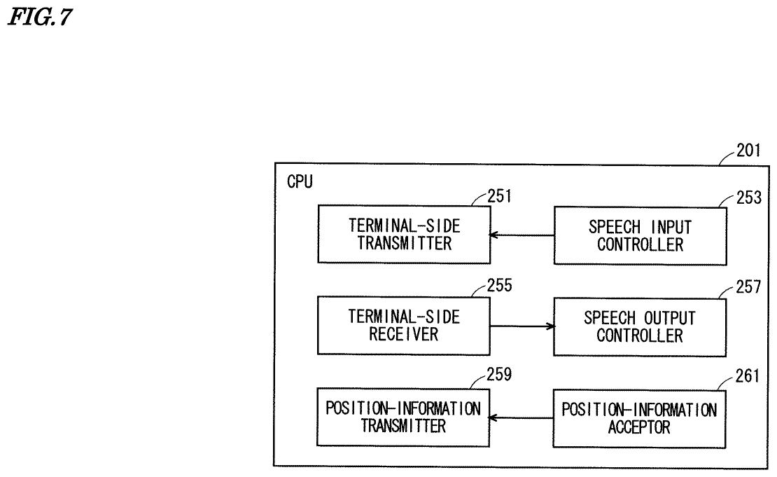

FIG. 7 is a diagram illustrating one example of the functions of a CPU included in a PC in the present embodiment. The functions illustrated in FIG. 7 are implemented by the CPU 201 of the PC 200 when the CPU 201 executes a terminal-side remote conference program stored in the ROM 202, the HDD 204 or the CD-ROM 211A. The terminal-side remote conference program is part of the remote conference program. With reference to FIG. 7, the CPU 201 included in the PC 200 includes a terminal-side transmitter 251, a speech input controller 253, a terminal-side receiver 255, a speech output controller 257, a position-information transmitter 259 and a position-information acceptor 261.

The speech input controller 253 receives an analog speech data piece output by the microphone 210. The speech input controller 253 converts the analog speech data piece into a digital speech data piece, and outputs the converted speech data piece to the terminal-side transmitter 251. The speech input controller 253 may compress the speech data piece and output the compressed speech data piece to the terminal-side transmitter 251. The terminal-side transmitter 251 controls the communication section 205 to transmit the speech data piece received from the speech input controller 253 to the server 100.

The terminal-side receiver 255 controls the communication section 205 to receive a speech data piece from the server 100. The terminal-side receiver 255 outputs the speech data piece received from the server 100 to the speech output controller 257. The speech output controller 257 reproduces the speech data piece. Specifically, the speech output controller 257 converts the speech data piece of a digital signal into an analog signal, and outputs the analog speech data piece to the speaker 209. Thus, the speech of the speech data piece is output from the speaker 209.

The position-information acceptor 261 receives the position information of the PC 200. The position-information acceptor 261 receives the environment information setting screen illustrated in FIG. 5 from the server 100, and displays the environment information setting screen on the display part 206. The position-information acceptor 261 accepts relative position information input to the operation part 207 by a user. Relative position information is the user identification information of another user who utters a speech that can be heard by the user. The position-information acceptor 261 outputs the relative position information to the position-information transmitter 259. The position-information transmitter 259 controls the communication section 205 to transmit the relative position information to the server 100.

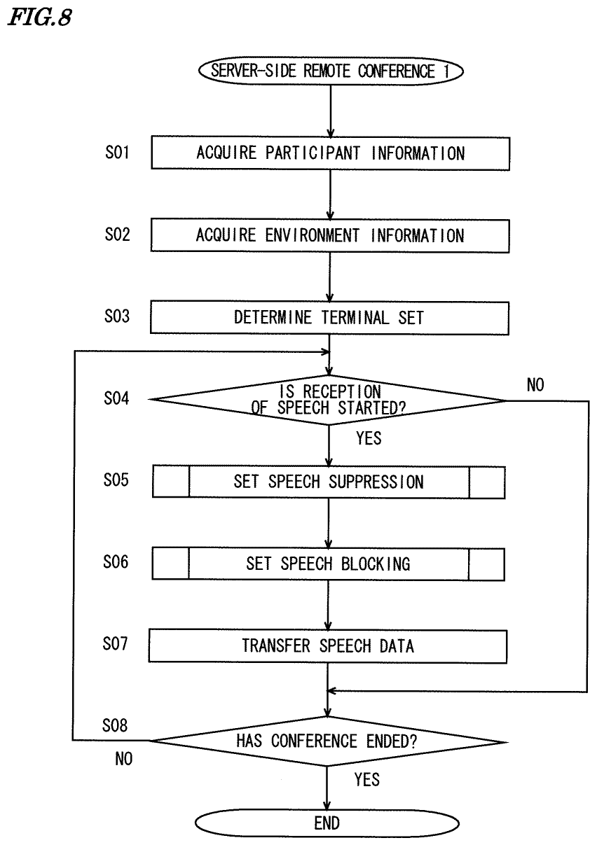

FIG. 8 is a flowchart illustrating one example of a flow of a server-side remote conference process. The server-side remote conference process is a process executed by the CPU 101 included in the server 100 when the CPU 101 executes the server-side remote conference program stored in the ROM 102, the HDD 104 or the CD-ROM 111. With reference to FIG. 8, the CPU 101 included in the server 100 acquires participant information (step S01), and the process proceeds to the step S02. In a case in which each of the users P-1 to P-N operates each of the PCs 200-1 to 200-N and performs an operation of logging into the server 100, the CPU 101 determines that the user permitted to log in is a participant of a remote conference. The CPU 101 acquires, as participant information, the user identification information of a user who is a participant. Here, the users P-1 to P-N are permitted to log in, by way of example.

In the step S02, environment information is acquired, and the process proceeds to the step S03. An environment information setting screen is transmitted to each of the PCs 200-1 to 200-N operated by each of the users P-1 to P-N, and the relative position information piece transmitted from each of the PCs 200-1 to 200-N in accordance with an input operation performed by each of the users P-1 to P-N is acquired. Then, an environment information piece is acquired from the relative position information piece.

In the step S03, a terminal set is determined, and the process proceeds to the step S04. An environment information piece includes a device identification information piece for identifying the PC 200 operated by each of two users who hear each other. The CPU 101 determines one or more terminal sets based on one or more environment information pieces. The CPU 101 generates a terminal-set table and stores the terminal-set table in the HDD 104. Here, a terminal set of the PC 200-1 and the PC 200-2 and a terminal set of the PC 200-2 and the PC 200-3 are determined, by way of example.

In the step S04, it is determined whether reception of a speech data piece has been started. If the reception of a speech data piece has been started, the process proceeds to the step S05. If not, the process proceeds to the step S08. The determination is made based on whether a speech data piece has been received from any of the PCs 200-1 to 200-N.

In the step S05, a speech suppressing process is executed, and the process proceeds to the step S06. In the step S06, a speech blocking process is executed, and the process proceeds to the step S07.

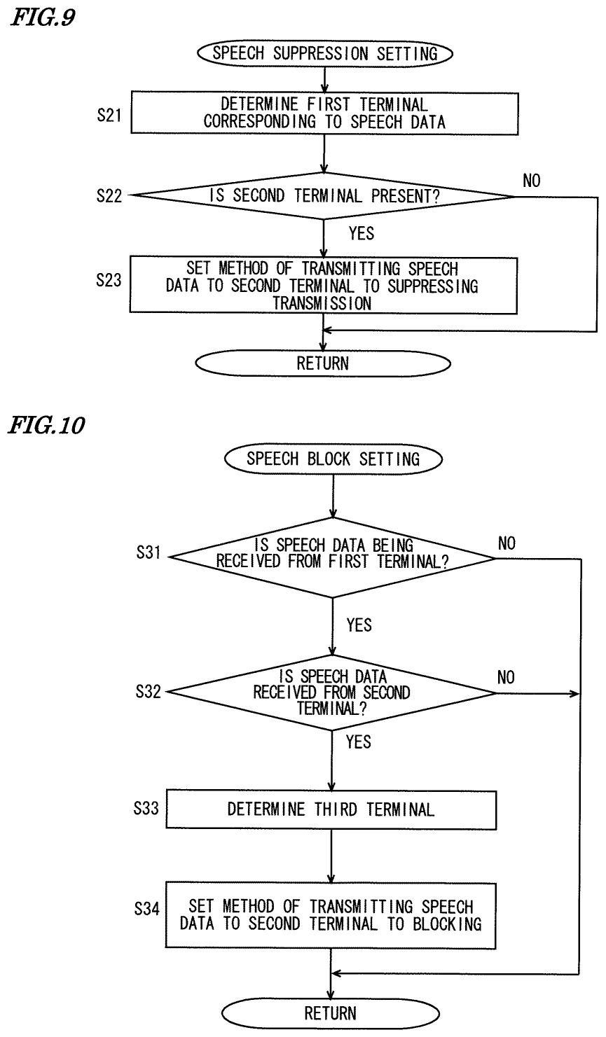

FIG. 9 is a flowchart illustrating one example of a speech suppressing process. A speech data piece is received from any of the PCs 200-1 to 200-N before the speech suppressing process is executed. With reference to FIG. 9, a first terminal corresponding to the speech data piece is determined (step S21), and the process proceeds to the step S22. One of the PCs 200-1 to 200-N that has transmitted the speech data piece is determined as the first terminal. The PC 200-2 is determined as the first terminal, by way of example.

In the step S22, whether a second terminal corresponding to the speech data piece is present is determined. With reference to a terminal-set table stored in the HDD 104, whether a second terminal that is paired with the PC 200-2, which is the first terminal, as a terminal set is present is determined. Whether a terminal set including the device identification information of the PC 200-2, which is the first terminal, is included in the terminal-set table is determined. If the terminal set including the device identification information of the PC 200-2, which is the first terminal, is present, a second terminal is determined based on the terminal set. If a second terminal corresponding to the first terminal is present, the process proceeds to the step S23. If not, the process returns to the server-side remote conference process. Here, because the PC 200-2 and the PC 200-1 are set to be paired as a terminal set, and the PC 200-2 and the PC 200-3 are set to be paired as a terminal set, the PC 200-1 and the PC 200-3 are specified as second terminals.

In the step S23, a method of transmitting a speech data piece to a second terminal is set to suppressing transmission, and the process returns to the server-side remote conference process. The speech data to be transmitted to the second terminal is the speech data transmitted from the PC 200-2 which is the first terminal. The transmission method as the suppressing transmission is one of a process of not transmitting a speech data piece and a process of converting the speech data piece into a speech data piece with a reduced sound volume level and transmitting the speech data piece with a reduced sound volume level.

FIG. 10 is a flowchart illustrating one example of a speech blocking process. With reference to FIG. 10, whether a speech data piece is being received from a first terminal is determined (step S31). If the speech data piece is being received from the first terminal, the process proceeds to the step S32. If not, the process returns to the server-side remote conference process.

In the step S32, whether a speech data piece has been received from a second terminal is determined. The second terminal here is a second terminal that is determined as being corresponding to the speech data piece transmitted from the first terminal, and is the PC 200-1 or the PC 200-3. If the speech data piece has been received from the second terminal (YES in the step S32), the process proceeds to the step S33. If not, the process returns to the server-side remote conference process.

In the step S33, a third terminal is determined, and the process proceeds to the step S34. The third terminal corresponding to the speech data piece that has been transmitted from the first terminal is determined. Here, the PCs 200-4 to 200-N are determined as the third terminals.

In the step S34, a method of transmitting a speech data piece to the second terminal is set to blocking, and the process returns to the server-side remote conference process.

Returning to FIG. 8, a speech data piece is transferred in the step S07, and the process proceeds to the step S08. In a case in which a method of transmitting a speech data piece that has been received from a first terminal to a second terminal is set to suppressing transmission, the CPU 101 does not transmit the speech data piece that has been received from the first terminal to the second terminal, or transmits the speech data piece that has been converted into a speech data piece with a reduced sound volume level to the second terminal. Here, the CPU 101 does not transmit a speech data piece D-2 that has been received from the PC 200-3, which is a first terminal, to the PC 200-1 or the PC 200-3, which is a second terminal corresponding to the speech data piece D-2, or transmits a speech data piece with a reduced sound volume level to the PC 200-1 and the PC 200-3. Further, in a case in which a method of transmitting a speech data piece that has been received from a second terminal is set to blocking, the CPU 201 does not transmit the speech data piece that has been received from the second terminal to a first terminal or a third terminal.

Here, the CPU 101 does not transmit a speech data piece D-1 that has been received from the PC 200-1, which is a second terminal, to the PC 200-2, which is a first terminal corresponding to the speech data piece D2, or the PCs 200-3 to 200-N, which are third terminals corresponding to the speech data piece D2. Further, the CPU 101 does not transmit a speech data piece D-3 that has been received from the PC 200-3, which is a second terminal corresponding to the speech data piece D-2, to the PC 200-2, which is a first terminal corresponding to the speech data piece D-2, or the PCs 200-1, 200-4 to 200-N, which are third terminals corresponding to the speech data piece D-2. The CPU 101 transmits a speech data piece that has been received from a first terminal to a third terminal, without modification. Here, the CPU 101 transmits the speech data piece D-2 that has been received from the PC 200-2, which is a first terminal corresponding to the speech data piece D-2, to the respective PCs 200-4 to 200-N, which are third terminals corresponding to the speech data piece D-2, without modification.

In the step S08, whether a conference has ended is determined. In a case in which an end command is received from one of the PCs 200-1 to 200-N, it is determined that the conference has ended. If the conference has ended, the process ends. If not, the process returns to the step S04.

Speech data pieces may be received from the PC 200-1 and the PC 200-3 that respectively make terminal sets with the PC 200-2. For example, in a period during which a speech data piece D1 is received from the PC 200-1, a speech data piece D-3 may be received from the PC 200-3. In regard to the speech data piece D-3, the PC 200-3 is determined as a first terminal, the PC 200-2 is determined as a second terminal, and the PCs 200-1, 200-4 to 200-N are determined as third terminals. Therefore, the speech data piece D-3 is not transmitted to the PC 200-2, which is the second terminal corresponding to the speech data piece D-3, or is transmitted to the PC 200-2 as a speech data piece with a low sound volume level. Further, a speech data piece D-2 received from the PC 200-2, which is a second terminal corresponding to the speech data piece D-3, is not transmitted to the PCs 200-3, 200-1, 200-4 to 200-N, which are first and third terminals corresponding to the speech data piece D-3. The CPU 101 transmits the speech data piece D-3 to the respective PCs 200-1, 200-4 to 200-N, which are the third terminals corresponding to the speech data piece D-3.

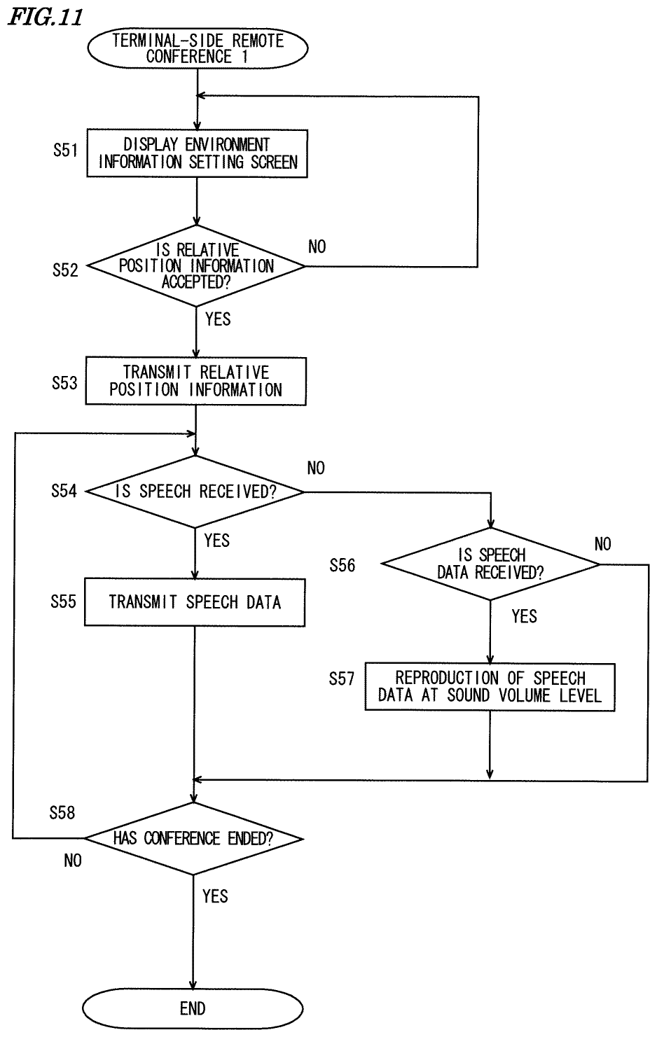

FIG. 11 is a flowchart illustrating one example of a terminal-side remote conference process. The terminal-side remote conference process is a process executed by the CPU 201 included in the PC 200 when the CPU 201 executes a terminal-side remote conference program stored in the ROM 202, the HDD 204 or the CD-ROM 211A. The terminal-side remote conference program is part of the remote conference program.

With reference to FIG. 11, the CPU 201 included in the PC 200 displays an environment information setting screen on the display part 206 (step S51), and the process proceeds to the step S52. In response to reception of the environment information setting screen by the communication section 205 from the server 100, the CPU 201 displays the environment information setting screen.

In the step S52, whether relative position information has been accepted is determined. Relative position information is accepted in accordance with a user's operation input to the operation part 207. If relative position information has been accepted (YES in the step S52), the process proceeds to step S53. If not, the process returns to the step S51. In the step S53, the relative position information is transmitted to the server 100, and the process proceeds to the step S54. The CPU 201 controls the communication section 205 to transmit the relative position information to the server 100.

In the step S54, whether a speech has been received is determined. The CPU 201 analyzes the output of the speaker 209. When a speech is detected from a speech data piece output by the speaker 209, it is determined that a speech has been received. If a speech has been received, the process proceeds to the step S55. If not, the process proceeds to the step S56. In the step S55, the speech data piece is transmitted to the server 100, and the process proceeds to the step S58. The CPU 201 controls the communication section 205 to transmit the speech data piece to the server 100.

In the step S56, whether a speech data piece has been received from the server 100 is determined. Whether the communication section 205 has received a speech data piece from the server 100 is determined. If a speech data piece has been received, the process proceeds to the step S57. If not, the process proceeds to the step S58. In the step S57, the received speech data piece is reproduced at a sound volume level defined in the speech data piece, and the process proceeds to the step S58.

In the step S58, whether a conference has ended is determined. When the communication section 205 receives a signal indicating the end of the conference from the server 100, the CPU 201 determines that the conference has ended. If the conference has not ended, the process returns to the step S54. If not, the process ends.

### First Modification Example

The environment detector 17 of the CPU 101 included in the server 100 may automatically detect, based on second type information, environment information without requiring an operation input by each of the users P-1 to P-N operating each of the PCs 200-1 to 200-N. Second type information is the information determined based on information detected by the PCs 200-1 to 200-N or information determined in advance in regard to the PCs 200-1 to 200-N.

The position-information acceptor 261 of the CPU 201 included in the PC 200 controls the GPS receiver 212 to acquire an absolute position. The position-information transmitter 259 transmits, to the server 100, absolute position information representing an absolute position acquired by the position-information acceptor 261.

Further, in a case in which a position table in which the positions at which the PCs 200-1 to 200-N are arranged are predetermined is prepared in advance, the environment detector 17 acquires the position table and acquires the absolute position information representing the current positions of the PC 200-1 to 200-N as second type information. The position table may be a seating chart that defines the seats of the users P-1 to P-N.

When acquiring the absolute position information from each of the PCs 200-1 to 200-N, the environment detector 17 specifies two devices having relative distances equal to or smaller than a predetermined length L from among the PCs 200-1 to 200-N, and detects the environment information including the device identification information of each of the specified two devices. The environment detector 17 outputs the detected environment information to the terminal-set determiner 19.

In a case in which the communication section 205 included in each of the PCs 200-1 to 200-N has a short-range wireless communication function, the environment detector 17 may acquire, from each of the PCs 200-1 to 200-N, first device identification information for identifying a device that is communicable by the short-range wireless communication function as second type information. The short-range wireless communication function is WiFi or Bluetooth (registered trademark), for example. Further, the short-range wireless communication function may be a communication function using infrared rays. The environment detector 17 determines relative information including first device identification information acquired from each of the PCs 200-1 to 200-N and second device identification information for identifying a device that has transmitted the first device identification information.

The environment detector 17 detects environment information including two device identification information pieces included in the relative position information based on the relative position information received from any one of the PCs 200-1 to 200-N. The environment detector 17 outputs the detected environment information to the terminal-set determiner 19.

### Second Modification Example

The environment detector 17 of the CPU 101 included in the server 100 may detect the environment information based on the first type of information and the second type of information. For example, the environment detector 17 may cause the PC 200-1 to display a list of environment information pieces determined based on the second type information. Further, the user P-1 operating the PC 200-1 may select the environment information from among the list of environment information, and the environment detector 17 may determine the selected environment information as the environment information to be actually used.

### Second Embodiment

The remote conference system 1 in the first embodiment converts speech data in the server 100. A remote conference system 1 in a second embodiment converts speech data in each of PCs 200-1 to 200-N. The differences of the remote conference system 1 in the second embodiment from the remote conference system 1 in the first embodiment will be mainly described below.

The system configuration of the remote conference system in the second embodiment is the same as the system configuration illustrated in FIG. 1. The hardware configuration of a server 100 in the second embodiment is the same as the hardware configuration illustrated in FIG. 2. The hardware configuration of the PCs 200-1 to 200-N in the second embodiment is the same as the hardware configuration illustrated in FIG. 3. Therefore, a description thereof will not be repeated.

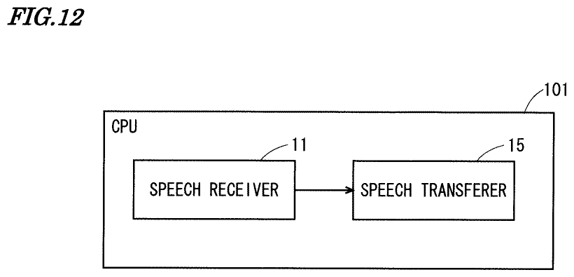

FIG. 12 is a diagram illustrating one example of the functions of a CPU included in the server in the second embodiment. With reference to FIG. 12, a CPU 101 included in the server 100 includes a speech receiver 11 and a speech transferer 15. The speech receiver 11 receives speech data from any of the PCs 200-1 to 200-N, and outputs the speech data to the speech transferer 15. The speech transferer 15 transmits the speech data received from the speech receiver 11 to all of the PCs 200-1 to 200-N except for a device that has transmitted the speech data. For example, the speech data that has been received from the PC 200-1 is transmitted to each of the PCs 200-2 to 200-N.

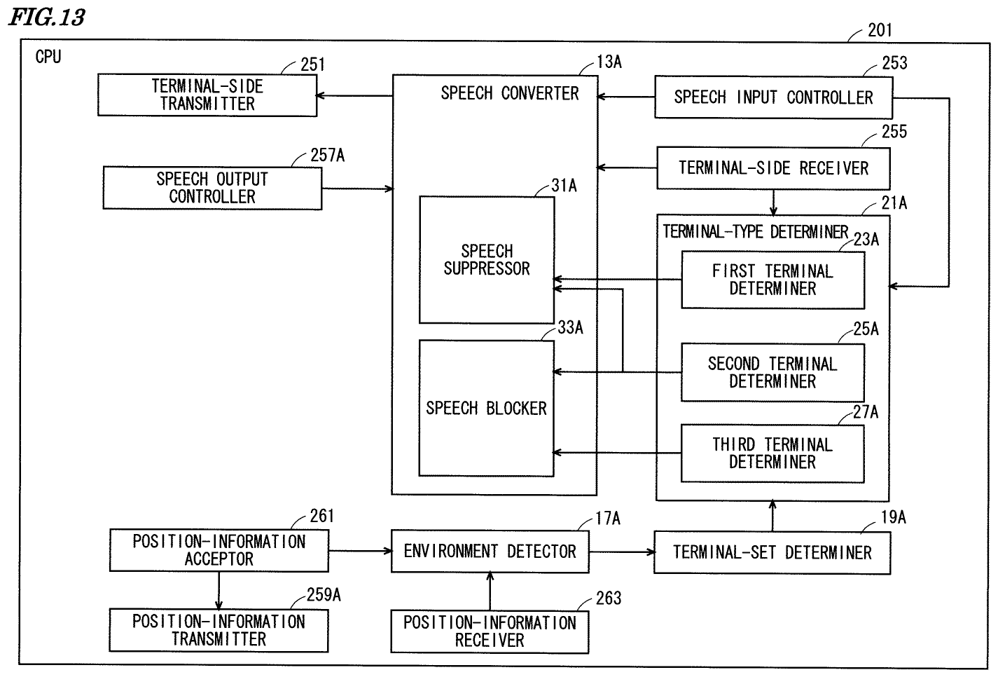

FIG. 13 is a diagram illustrating one example of the functions of a CPU included in a PC in the second embodiment. With reference to FIG. 13, the functions are different from those illustrated in FIG. 7 in that a speech converter 13A, an environment detector 17A, a terminal-set determiner 19A, a terminal-type determiner 21A and a position-information receiver 263 are added, and that the speech output controller 257 and the position-information transmitter 259 are respectively changed to a speech output controller 257A and a position-information transmitter 259A. Because the other functions are the same as those illustrated in FIG. 7, the description thereof will not be repeated here. Because the functions of the PCs 200-1 to 200-N are the same, the functions of the PC 200-1 will be described here as an example.

The environment information setting screen illustrated in FIG. 5 is stored in an HDD 204 of the PC 200-1. A position-information acceptor 261 displays the environment information setting screen illustrated in FIG. 5 on a display part 206. The position-information acceptor 261 accepts a relative position information piece input to an operation part 207 by a user, and outputs the relative position information piece to the position-information transmitter 259A. The position-information transmitter 259A controls a communication section 205 to transmit the relative position information piece to each of the other PCs 200-2 to 200-N. Note that the relative position information piece may be transmitted to the other PCs 200-2 to 200-N via the server 100.

The position-information receiver 263 controls the communication section 205 to receive the relative position information piece from each of the other PCs 200-2 to 200-N. The position-information receiver 263 outputs the relative position information piece received from each of the PCs 200-2 to 200-N to the environment detector 17A.

The environment detector 17A detects environment information pieces of users P-1 to P-N participating in a remote conference. In the present embodiment, the user P-1 can hear a speech uttered by the user P-2 but cannot hear a speech uttered by the user P-3, the user P-2 can hear speeches respectively uttered by the user P-1 and the user P-3, and the user P-3 can hear a speech uttered by the user P-2 but cannot hear a speech uttered by the user P-1.

With reference to a correspondence table which is stored in the HDD 204 in advance and in which the users P-1 to P-N are associated with the PCs 200-1 to 200-N, the environment detector 17A detects an environment information piece based on a relative position information piece received from the position-information acceptor 261 and a relative position information piece received from the position-information receiver 263. The environment detector 17A outputs the detected environment information piece to the terminal-set determiner 19A.

The terminal-set determiner 19A determines a terminal set based on the environment information piece received from the environment detector 17A. The terminal-set determiner 19A outputs the determined terminal set to the terminal-type determiner 21A.

In the present embodiment, the terminal-set determiner 19A determines one terminal set based on one environment information piece. The terminal-set determiner 19A stores, in the HDD 204, the terminal-set table representing terminal sets and being illustrated in FIG. 6.

The terminal-type determiner 21A receives a terminal set from the terminal-set determiner 19A, receives a device identification information piece of a device that has transmitted a speech data piece from the terminal-side receiver 255, and receives a device identification information piece of a PC itself from the speech input controller 253. The terminal-type determiner 21A includes a first-terminal determiner 23A, a second-terminal determiner 25A and a third-terminal determiner 27A.

In response to receiving a device identification information piece from one of the speech input controller 253 and the terminal-side receiver 255, the first-terminal determiner 23A determines a device specified by the device identification information piece as a first terminal. The first-terminal determiner 23A outputs the device identification information piece for identifying the first terminal 1 to the speech converter 13. A device identification information piece of a PC itself is received from the speech input controller 253.

With reference to a terminal set received from the terminal-set determiner 19A, the second-terminal determiner 25A determines, as a second terminal, a device to be paired with the first terminal. The second-terminal determiner 25A outputs a device identification information piece for identifying the second terminal to the speech converter 13.

The third-terminal determiner 27A determines devices other than the first terminal and the second terminal among the PCs 200-1 to 200-N as third terminals. The third-terminal determiner 27A outputs a device identification information piece for identifying the third terminal to the speech converter 13A.

The terminal-type determiner 21A determines a first terminal, a second terminal and a third terminal relative to a speech data piece. A first terminal, a second terminal and a third terminal determined relative to a speech data piece have been described above. Therefore, a description thereof will not be repeated here.

The speech converter 13A receives a speech data piece from the speech input controller 253 and the terminal-side receiver 255, and receives a device identification information piece of each of a first terminal, a second terminal and a third terminal from the terminal-type determiner 21A. The speech converter 13 converts the speech data piece received from the speech receiver 11 for each output destination.

The speech converter 13A includes a speech suppressor 31A and a speech blocker 33A. In a case in which a PC itself is a second terminal in regard to a speech data piece received from a first terminal, the speech suppressor 31A suppresses the speech data piece received from the first terminal. Specifically, the speech suppressor 31A makes setting such that the speech data piece received from the first terminal is not reproduced. Further, the speech suppressor 31A sets the sound volume level of the speech data piece received from the first terminal to a level lower than a normally set sound volume level. A sound volume level is part of a speech data piece, and is a value indicating a sound volume level when a speech of the speech data piece is reproduced.

The speech blocker 33A blocks a speech data piece received from a second terminal. Specifically, the speech blocker 33A makes setting such that a speech data piece, which the terminal-side receiver 255 has received from a second terminal, is not reproduced.

Two devices, respectively specified by two device identification information pieces, included in a terminal set, have a positional relationship in which two users operating these devices can hear a speech uttered by another user. Here, the PC 200-1 and the PC 200-2 are included in a terminal set, and the PC 200-2 and the PC 200-3 are included in a terminal set, by way of specific example. In this case, each of the user P-1 and the user P-3 directly hears a speech uttered by the user P-2. On the other hand, because a speech uttered by the user P-2 in a remote conference is collected by the microphone 210 of the PC 200-2, the terminal-side receiver 255 receives a speech data piece D-2 representing the speech uttered by the user P-2 from the PC 200-2. In this case, it is determined that, in regard to the speech data piece D-2, the PC 200-2 is a first terminal, the PC 200-1 and the PC 200-3 are second terminals, and the PCs 200-4 to 200-N are third terminals. Because the PC 200-1 is the second terminal corresponding to the speech data piece D-2, the speech suppressor 31A makes setting such that the speech data piece D-2 is not to be reproduced. Therefore, a reproduced speech of the speech data piece D-2 is not output from the speaker 209 included in the PC 200-1. Therefore, it is possible to prevent the user P-1 from hearing the same speech from two sound sources. Further, the speech suppressor 31A sets the sound volume level of the speech data piece D-2 to a low level. Therefore, a reproduced speech of the speech data piece D-1 is output from the speaker 209 included in the PC 200-1 at a low sound volume level. Therefore, it is possible to allow the user P-1 to hear to the same speech from the two sound sources at different sound volume levels.

Further, a speech uttered by the user P-2 in a remote conference is collected by the microphone 210 included in the PC 200-2 and is also collected by the microphone 210 included in the PC 200-3. Therefore, the terminal-side receiver 255 receives, from the PC 200-3, a speech data piece D-3 representing the speech uttered by the user P-2. Because the PC 200-3 is a second terminal corresponding to the speech data piece D-2, the speech blocker 33A makes setting such that the speech data piece D-3 received from the PC 200-3, which is the second terminal corresponding to the speech data piece D-2, in a period during which the speech data piece D-2 is received from the PC 200-2, which is a first terminal.

Therefore, because the speech data piece D-3 is not reproduced, the speech uttered by the user P-2 is not output from the speaker 209 included in the PC 200-1. Therefore, it is possible to prevent the user P-1 from hearing the same speech uttered by the user P-2 from two sound sources.

The speech output controller 257A receives a speech data piece that has been converted by the speech converter 13. The speech output controller 257A does not reproduce a speech data piece, which is set not to be reproduced. Further, the speech output controller 257A reproduces a speech data piece having a low sound volume level at a sound volume level lower than a normal sound volume level.

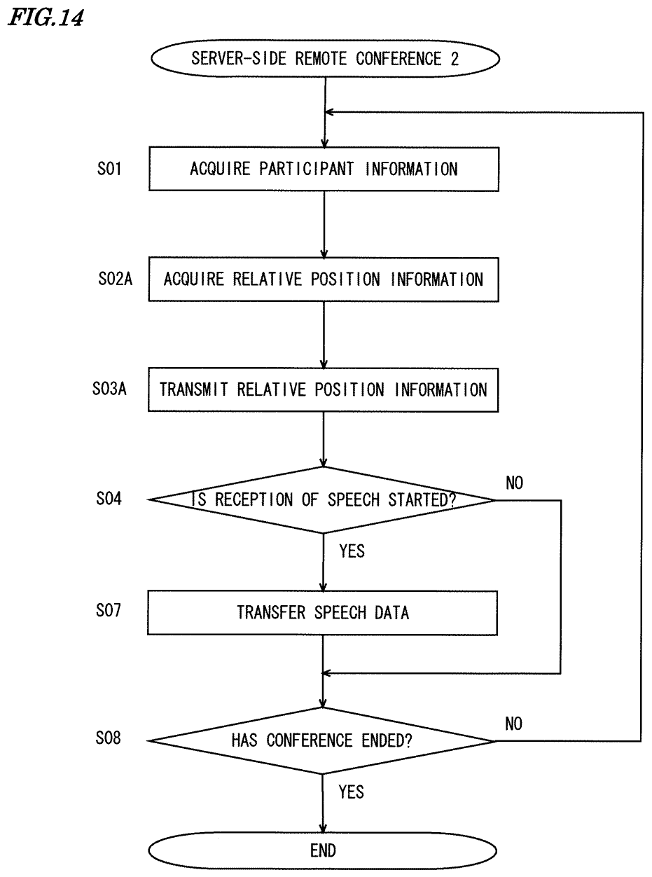

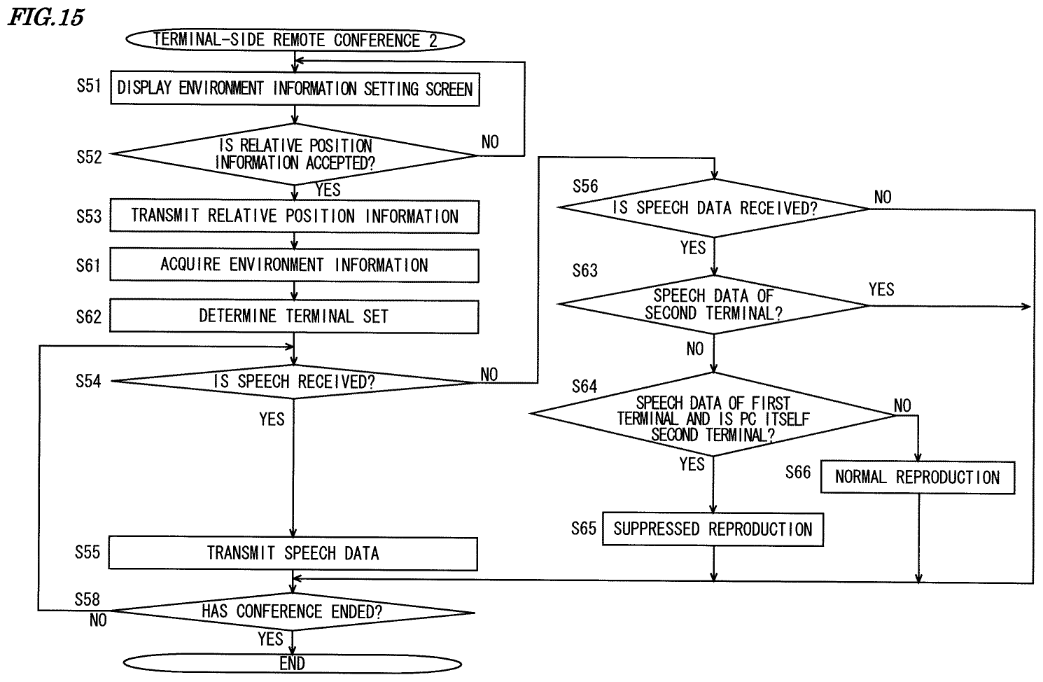

FIG. 14 is a flowchart illustrating one example of a flow of a server-side remote conference process in the second embodiment. With reference to FIG. 14, the differences from the process illustrated in FIG. 8 is that the step S02 and the step S03 are changed to the step S02A and the step S03A, and that the step S05 and the step S06 are not performed. The other processes are the same as the processes those illustrated in FIG. 5. Therefore, a description thereof will not be repeated here. In the step S02A, relative position information is acquired, and the process proceeds to the step S03A. The relative position information transmitted from each of the PCs 200-1 to 200-N is acquired according to each of the operations input by the users P-1 to P-N.

In the step S03A, the relative position information is transmitted to each of the PCs 200-1 to 200-N, and the process proceeds to the step S04. When reception of a speech data piece is started in the step S04, the process proceeds to the step S07. If not, the process proceeds to the step S08.

FIG. 15 is a first flowchart illustrating one example of a flow of a terminal-side remote conference process in the second embodiment. The terminal-side remote conference process in the second embodiment is different from the process illustrated in FIG. 11 in that the step S61 and the step S62 are added between the step S53 and the step S54, and the step S57 is changed to the process of the steps S63 to the steps S66. The other processes are the same as the processes those illustrated in FIG. 11. Therefore, a description thereof will not be repeated here.

In the step S61, environment information is acquired, and the process proceeds to the step S62. The environment information is acquired from relative position information accepted in the step S52 and relative position information received from each of the other PCs 200-1 to 200-N.

In the step S62, a terminal set is determined, and the process proceeds to the step S54. An environment information piece includes a device identification information piece for identifying the PC 200 operated by each of two users who hear each other. The CPU 201 determines one or more terminal sets based on one or more environment information pieces. The CPU 201 generates a terminal-set table and stores the terminal-set table in the HDD 204. Here, a terminal set of the PC 200-1 and the PC 200-2 and a terminal set of the PC 200-2 and the PC 200-3 are determined, by way of example.

In a case in which it is determined in the step S56 that a speech data piece has been received, the process proceeds to the step S63. In the step S63, it is determined whether the received speech data piece is the speech data piece of a second terminal. A first terminal, a second terminal and a third terminal corresponding to the speech data piece received in the step S56 are determined. Whether the speech data piece that is received in the step S56 is a speech data piece that has been received from a second terminal is determined. If the speech data piece that has been transmitted from the second terminal is received, the process proceeds to the step S58. If not, the process proceeds to the step S64. Therefore, the speech data piece that has been received from the second terminal is not reproduced.

In the step S64, whether the speech data piece is the speech data piece of the first terminal, and a PC itself is the second terminal is determined. The first terminal, the second terminal and the third terminal corresponding to the speech data piece received in the step S56 are determined. It is determined whether the speech data piece received in the step S56 is the speech data piece received from the first terminal and the PC itself is the second terminal corresponding to the speech data piece. If the speech data piece transmitted from the first terminal is received and the PC itself serves as the second terminal corresponding to the speech data piece, the process proceeds to the step S65. If not, the process proceeds to the step S66.

In the step S65, the speech data piece is reproduced in a suppressed manner, and the process proceeds to the step S58. The speech data piece received in the step S56 is reproduced in a suppressed state. Specifically, the CPU 201 does not reproduce the speech piece data received in the step S56, or reproduces the speech data piece at a sound volume level lower than a normal sound volume level.

In the step S66, the speech data piece is normally reproduced, and the process proceeds to the step S58. The speech data piece received in the step S56 is reproduced at the normal sound volume level.

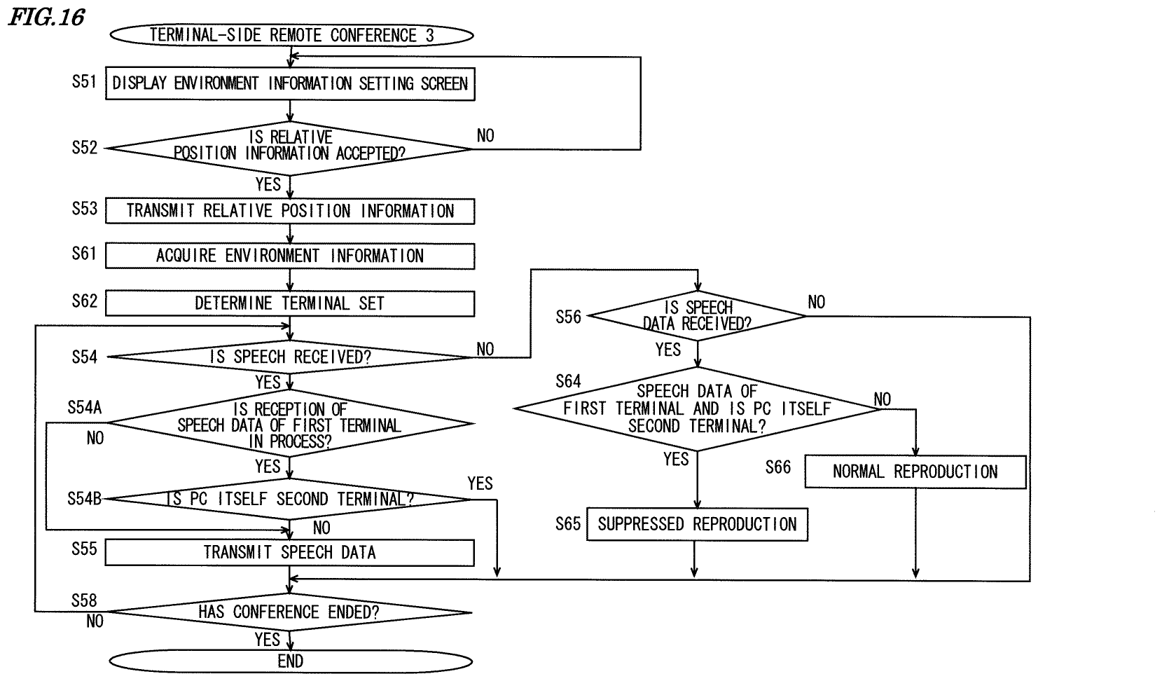

In a case in which the PC itself is the second terminal, the speech data piece may be prevented from being transmitted. One example of a flowchart for this case is illustrated in FIG. 16. With reference to FIG. 16, the differences from FIG. 15 are that the step S63 is not performed, and the step S54A and the step S54B are added between the step S54 and the step S55. The other processes are the same as the processes illustrated in FIG. 15. Therefore, a description thereof will not be repeated here.

In a case in which it is detected in the step S54 that a speech has been received, the process proceeds to the step S54A. In the step S54A, whether a speech data piece of a first terminal is being received is determined. If the speech data piece received in the step S56 is the speech data piece of the first terminal, and the reception of the speech data piece is in progress, the process proceeds to the step S54B. If not, the process proceeds to the step S55. In the step S54B, whether a PC itself is a second terminal corresponding to the speech data piece received in the step S56 is determined. If the PC itself is the second terminal corresponding to the speech data piece received in the step S56, the process proceeds to the step S58. If not, the process proceeds to the step S55. In a case in which the process proceeds to the step S55, the speech received in the step S54 is converted into a speech data piece, and the speech data piece is transmitted to the server 100 via a communication section 205. In a case in which the process proceeds to the step S58, the speech received in the step S54 is not converted into a speech data piece or processed.

As described above, the remote conference system 1 in the present embodiment is a system in which the PCs 200-1 to 200-N are connected to the Internet 5, and speeches received by these terminals are distributed to other terminals. The distribution of a speech or the reproduction of a speech by a terminal is controlled such that a reproduction sound volume level at a second terminal of a speech of a first terminal among the PCs 200-1 to 200-N is suppressed to be lower than a reproduction sound volume level at a third terminal. Therefore, in regard to a speech of a first terminal, a reproduction sound volume level at a second terminal is suppressed to be lower than a reproduction sound volume level at a third terminal. For example, a speech of the user P-2 operating the PC 200-2, which is a first terminal, may be directly transmitted to the user P-1 operating the PC 200-1, which is a second terminal. In this case, the user P-1 hears a speech uttered by the user P-2, and a speech that is reproduced by the PC 200-1 when the speech is input to the PC 200-2. Further, the speech of the user P-2 reproduced by the PC 200-1 is reproduced later than the speech uttered by the user P-2. Because the speech uttered by the user P-2 is input to the PC 200-2 and the speech reproduced by the PC 200-1 is suppressed, it is possible to cause the user P-1 to preferentially hear to the speech uttered by the user P-2. Therefore, it is possible to suppress an event in which the same speech is heard from a plurality of sound sources.

Further, a first terminal and a second terminal are selected in accordance with an operation performed by a user of any one of the PCs 200-1 to 200-N as information for specifying a terminal set. Therefore, it is possible to reliably suppress an event in which the same speech is heard from a plurality of sound sources, and it is possible to prevent a speech that does not need to be suppressed from being suppressed.

Further, a first terminal is selected based on the distance from a second terminal. Therefore, the first terminal and the second terminal can be automatically selected.

Further, a speech of a first terminal is not delivered to a second terminal or is not reproduced by the second terminal, and the speech of the first terminal is delivered to a third terminal or is reproduced by the third terminal. Therefore, because a speech uttered by the user P-2 operating the PC 200-2, which is a first terminal, is not reproduced by the PC 200-1, which is a second terminal, the user P-1 operating the PC 200-1 can directly hear only the speech uttered by the user P-2. The users P4 to P-N who operate the PCs 200-4 to 200-N, which are third terminals, can respectively hear a speech uttered by the user P-2 from the PCs 200-4 to 200-N because the PCs 200-4 to 200-N respectively reproduce the speech uttered by the user P-2.

Further, a speech of a speech data piece received from the PC 200-2, which is a first terminal, is reproduced by each of the PC 200-1 and the PC 200-3, which are second terminals, at a sound volume level lower than a sound volume level at which the speech of the speech data piece is reproduced by each of the PCs 200-4 to 200-N, which are third terminals. Therefore, a speech uttered by the user P-2 is reproduced by each of the PC 200-1 and the PC 200-3, which are second terminals, at a sound volume level lower than a sound volume level at which the speech is reproduced by each of the PCs 200-4 to 200-N, which are third terminals. In regard to a speech uttered by the user P-2, each of the user P-1 and the user P-3 hears the speech uttered by the user P-2 and the speech reproduced by each of the PC 200-1 and the PC 200-3, which are second terminals. However, because the speech is reproduced at a low sound volume level, each of the user P-1 and the user P-3 can preferentially and directly hear the speech from the user P-2.

Further, speech data pieces received from the PC 200-1 and the PC 200-3, which are second terminals, are not distributed to the PCs 200-2, 200-4 to 200-N, which are other terminals, or are not reproduced by the PCs 200-2, 200-4 to 200-N. Therefore, in the PCs 200-2, 200-4 to 200N, a speech of a speech data piece received from the PC 200-2, which is a first terminal, is identified as a speech uttered by the user P-2, and speeches of a speech data piece D-1 and a speech data piece D-3 respectively received from the PC 200-1 and the PC 200-3, which are second terminals, are respectively identified as the speeches uttered by the user P-1 and the user P-3. In this case, the speeches of the speech data piece D-1 and the speech data piece D-3 respectively received from the PC 200-1 and the PC 200-3 are respectively identified as the speeches uttered by the users P-1 and the user P-2, even though they are the speeches uttered by the user P-2. The speeches of the speech data piece D-1 and the speech data piece D-3 respectively received from the PCs 200-1 and the PC 200-3, which are second terminals, are not distributed to or reproduced by the other terminals. Therefore, speakers are prevented from being erroneously identified by the other terminals.

### Overview of Embodiments

(Item 1) A remote conference system in which at least three terminals are communicably connected and which distribute speeches received by these terminals to other terminals, and includes a hardware-processor, wherein the hardware-processor, in regard to a speech of a first terminal among the at least three terminals, controls distribution of the speech to a terminal or reproduction of the speech by a terminal such that a sound volume level of reproduction by a second terminal among the at least three terminals is suppressed to be lower than a sound volume level of reproduction by a third terminal.

According to this aspect, in regard to a speech of the first terminal, a reproduction sound volume level at the second terminal is suppressed to be lower than a reproduction sound volume level at the third terminal. The speech uttered by a first user operating the first terminal may be directly transmitted to a second user operating the second terminal. In this case, the second user hears a speech uttered by the first user and a speech that is input to the first terminal and reproduced by the second terminal. Further, the speech uttered by the first user and reproduced by the second terminal is reproduced later than the speech uttered by the first user. Because the speech, which is uttered by the first user, input to the first terminal and then reproduced by the second terminal, is suppressed, it is possible to cause the second user to preferentially hear the speech uttered by the first user. Therefore, it is possible to provide a remote conference system that suppresses an event in which the same speech is heard from a plurality of sound sources while reproducing speeches of a plurality of participants.
(Item 2) The remote conference system according to item 1, wherein the hardware-processor selects the first terminal and the second terminal in accordance with an operation performed by a user who operates any one of the at least three terminals.

According to this aspect, because the first terminal and the second terminal are selected in accordance with an operation performed by a user of any of at least three terminals, it is possible to reliably suppress an event in which the same speech is heard from a plurality of sound sources, and it is possible to prevent a speech that does not need to be suppressed from being suppressed.
(Item 3) The remote conference system according to item 1, wherein the hardware-processor selects the first terminal based on a distance from the second terminal.

According to this aspect, because the first terminal is selected based on the distance from the second terminal, the first terminal and the second terminal can be automatically selected.
(Item 4) The remote conference system according to any one of items 1 to 3, wherein the hardware-processor does not distribute a speech of the first terminal to the second terminal or does not cause the second terminal to reproduce the speech, but distributes the speech of the first terminal to the third terminal or causes the third terminal to reproduce the speech.

According to this aspect, the speech of the first terminal is not reproduced by the second terminal, but is reproduced by the third terminal. Therefore, because a speech uttered by the first user operating the first terminal is not reproduced by the second terminal, the second user operating the second terminal can directly hear only the speech uttered by the first user in regard to the speech uttered by the first user. Because the third terminal reproduces the speech uttered by the first user operating the first terminal, the user operating the third terminal can hear the speech only from the third terminal.
(Item 5) The remote conference system according to any one of items 1 to 4, wherein the hardware-processor distributes a speech of the first terminal to the third terminal or causes the third terminal to reproduce the speech, and distributes the speech of the first terminal to the second terminal with a sound volume level lower than a sound volume level of the speech distributed to the third terminal or causes the second terminal to reproduce the speech of the first terminal at a sound volume level lower than a sound volume level at which the third terminal reproduces the speech.

According to this aspect, the speech of the first terminal is reproduced by the second terminal at a sound volume level lower than a sound volume level at which the speech is reproduced by the third terminal. Therefore, the speech uttered by the first user operating the first terminal is reproduced by the second terminal at a sound volume level lower than a sound volume level at which the speech is reproduced by the third terminal. In regard to the speech uttered by the first user, the second user operating the second terminal hears the speech uttered by the first user and the speech reproduced by the second terminal. However, because the speech reproduced by the second terminal is reproduced at a sound volume level lower than a sound volume level at which the speech is reproduced by the third terminal, the second user can preferentially hear the speech directly from the first user.
(Item 6) The remote conference system according to any one of items 1 to 5, wherein the hardware-processor does not distribute a speech of the second terminal to another terminal or does not cause the another terminal to reproduce the speech.

According to this aspect, because a speech of the second terminal is not distributed to or reproduced by the other terminals, a speech uttered by the user operating the first terminal, which is input to the second terminal, is not reproduced by the other terminals. When a speech uttered by the user operating the first terminal is input to the second terminal, the speech uttered by the user operating the first terminal is reproduced by another terminal as a speech of the first terminal and a speech of the second terminal. Therefore, in a case in which a speech of the first terminal is identified as a speech uttered by the first user operating the first terminal, and a speech of the second terminal is identified as a speech uttered by the second user operating the second terminal, the speech of the second terminal is identified as a speech uttered by the second user regardless of being a speech uttered by the first user. Because a speech of the second terminal is not distributed to or reproduced by another terminal, it is possible to prevent a speaker from being erroneously specified by another terminal.
(Item 7) The remote conference system according to any one of items 1 to 6, further includes a server communicably connected to the at least three terminals, wherein the server includes the hardware-processor.

According to this aspect, because the server includes the controller, the server can control a speech reproduced by a plurality of terminals. Therefore, the configuration of the remote conference system can be simplified.
(Item 8) The remote conference system according to any one of items 1 to 6, wherein each of the at least three terminals includes the hardware-processor.

According to this aspect, because each of the at least three terminals includes the controller, it is possible to control a speech reproduced by each of the at least three terminals. Therefore, a user operating each of the at least three terminals can switch a speech to be reproduced, and the convenience for the user can be improved.
(Item 8) A non-transitory computer readable recording medium is encoded with a remote conference program executed by a computer to which at least three terminals are communicably connected, and the remote conference program causes the computer to execute a distribution step of distributing speeches respectively received by the at least three terminals to other terminals, wherein the distribution step, in a case in which a speech of a first terminal among the at least three terminals is distributed, includes suppressing a sound volume level of reproduction by a second terminal among the at least three terminals such that the sound volume level of reproduction by the second terminal is lower than a sound volume level of reproduction by a third terminal.

According to this aspect, it is possible to provide the remote conference program that suppresses an event in which the same speech is heard from a plurality of sound sources while speeches uttered by a plurality of participants are reproduced.
(Item 10) A non-transitory computer readable recording medium is encoded with a remote conference program executed by a computer controlling a terminal communicably connected to at least two terminals which are a first terminal and a second terminal, and the remote conference program causes the computer to execute a distribution step of distributing a received speech to the first terminal and the second terminal, and a reproduction step of reproducing a speech distributed from any one of the first terminal and the second terminal, wherein the reproduction step includes suppressing a sound volume level of reproduction of a speech distributed from the first terminal such that the sound volume level of reproduction of the speech is lower than a sound volume level of reproduction of a speech distributed from the second terminal.

According to this aspect, it is possible to provide the remote conference program that suppresses an event in which the same speech is heard from a plurality of sound sources while speeches uttered by a plurality of participants are reproduced.

Although embodiments of the present invention have been described and illustrated in detail, the disclosed embodiments are made for purpose of illustration and example only and not limitation. The scope of the present invention should be interpreted by terms of the appended claims.

What is claimed is:

1. A remote conference system in which at least three terminals are communicably connected and which distribute speeches received by these terminals to other terminals, comprising a hardware-processor, wherein
the hardware-processor, in regard to a speech of a first terminal among the at least three terminals, controls distribution of the speech to a terminal or reproduction of the speech by a terminal such that a sound volume level of reproduction by a second terminal among the at least three terminals is suppressed to be lower than a sound volume level of reproduction by a third terminal.

2. The remote conference system according to claim 1, wherein
the hardware-processor selects the first terminal and the second terminal in accordance with an operation performed by a user who operates any one of the at least three terminals.

3. The remote conference system according to claim 1, wherein
the hardware-processor selects the first terminal based on a distance from the second terminal.

4. The remote conference system according to claim 1, wherein
the hardware-processor does not distribute a speech of the first terminal to the second terminal or does not cause the second terminal to reproduce the speech, but distributes the speech of the first terminal to the third terminal or causes the third terminal to reproduce the speech.

5. The remote conference system according to claim 1, wherein
the hardware-processor distributes a speech of the first terminal to the third terminal or causes the third terminal to reproduce the speech, and distributes the speech of the first terminal to the second terminal with a sound volume level lower than a sound volume level of the speech distributed to the third terminal or causes the second terminal to reproduce the speech of the first terminal at a sound volume level lower than a sound volume level at which the third terminal reproduces the speech.

6. The remote conference system according to claim 1, wherein
the hardware-processor does not distribute a speech of the second terminal to another terminal or does not cause the another terminal to reproduce the speech.

7. The remote conference system according to claim 1, further comprising a server communicably connected to the at least three terminals, wherein
the server includes the hardware-processor.

8. The remote conference system according to claim 1, wherein
each of the at least three terminals includes the hardware-processor.

9. A non-transitory computer readable recording medium encoded with a remote conference program executed by a computer to which at least three terminals are communicably connected,
the remote conference program causes the computer to execute a distribution step of distributing speeches respectively received by the at least three terminals to other terminals, wherein
the distribution step, in a case in which a speech of a first terminal among the at least three terminals is distributed, includes suppressing a sound volume level of reproduction by a second terminal among the at least three terminals such that the sound volume level of reproduction by the second terminal is lower than a sound volume level of reproduction by a third terminal.

10. The non-transitory computer readable recording medium according to claim 9, wherein
the remote conference program further causes the computer to execute a step of selecting the first terminal and the second terminal in accordance with an operation performed by a user who operates any one of the at least three terminals.

11. The non-transitory computer readable recording medium according to claim 9, wherein
the remote conference program further causes the computer to execute a step of selecting the first terminal based on a distance from the second terminal.

12. The non-transitory computer readable recording medium according to claim 9, wherein
the remote conference program further causes the computer to execute a step of prohibiting a speech of the first terminal from being distributed to the second terminal or causing the second terminal not to reproduce the speech, but distributing the speech of the first terminal to the third terminal or causing the third terminal to reproduce the speech.

13. The non-transitory computer readable recording medium according to claim 9, wherein
the remote conference program further causes the computer to execute a step of distributing a speech of the first terminal to the third terminal or causing the third terminal to reproduce the speech, and distributing the speech of the first terminal to the second terminal with a sound volume level lower than a sound volume level of the speech distributed to the third terminal or causing the second terminal to reproduce the speech of the first terminal at a sound volume level lower than a sound volume level at which the third terminal reproduces the speech.

14. The non-transitory computer readable recording medium according to claim 9, wherein
the remote conference program further causes the computer to execute a step of prohibiting a speech of the second terminal from being distributed to another terminal or causing the another terminal not to reproduce the speech.

15. A non-transitory computer readable recording medium encoded with a remote conference program executed by a computer controlling a terminal communicably connected to at least two terminals which are a first terminal and a second terminal,
the remote conference program causing the computer to execute:
a distribution step of distributing a received speech to the first terminal and the second terminal; and
a reproduction step of reproducing a speech distributed from any one of the first terminal and the second terminal, wherein
the reproduction step includes suppressing a sound volume level of reproduction of a speech distributed from the first terminal such that the sound volume level of reproduction of the speech is lower than a sound volume level of reproduction of a speech distributed from the second terminal.

16. The non-transitory computer readable recording medium according to claim 15, wherein
the remote conference program further causes the computer to execute a step of selecting the first terminal in accordance with an operation performed by a user who operates any one of the first terminal and the computer itself.

17. The non-transitory computer readable recording medium according to claim 15, wherein
the remote conference program further causes the computer to execute a step of selecting the first terminal based on a distance from the computer.
